(19) United States
(12) Patent Application Publication
(10) Pub. No.: US 2007/0129524 A1
(43) Pub. Date: Jun. 7, 2007

(54) Thermoplastic polyurethanes comprising polytrimethylene ether soft segments

(76) Inventor: Hari Babu Sunkara, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/294,850

(22) Filed: Dec. 6, 2005

(51) Int. Cl. C08G 18/00

(52) U.S. Cl. 528/44

(57) ABSTRACT

Thermoplastic polyurethane prepared from reactants comprising: (a) polytrimethylene ether glycol; (b) diisocyanate; (c) diol chain extender; and (d) monofunctional alcohol chain terminator or monofunctional amine chain terminator; and manufacture and use thereof.

### FIELD OF THE INVENTION

This invention relates to thermoplastic polytrimethylene ether urethane compositions, processes for their manufacture, shaped articles comprising the thermoplastic polytrimethylene ether urethane compositions, processes for manufacture of the shaped articles, and use of the shaped articles.

### BACKGROUND OF THE INVENTION

Polyurethane polymers belong to the family of thermoplastic elastomers (TPE's) and are typical block copolymers comprising blocks of soft and hard segments. The soft segments are formed primarily from polyether or polyester polyol, and the hard segments are formed primarily from diisocyanate and chain extenders (the hydroxyl at the ends of the polyether glycols being considered to form part of the hard segment). Polyurethane elastomers are widely used to make spandex fibers, films, foams, resins, adhesives and coatings for various end uses, including automotive bumper covers, solid tires, industrial rollers, shoe soles and sport boots, as well as for biomedical and other applications.

Spandex fibers are segmented polyurethane-urea copolymers consisting of alternating polyurethane-urea hard segments and polyether or polyester soft segments. Both the polymerization process to make polymer and the dry spinning process to produce spandex fibers are carried out in the presence of a solvent, e.g. dimethyl formamide or dimethyl acetamide. In the dry spinning process a highly viscous solution is put through a spinneret and simultaneously, hot air is supplied to evaporate the solvent. Therefore, the dry spinning process is an expensive, complicated and environmentally unfriendly process. Furthermore, most of the ingredients used to make commercial polyurethane polymers and spandex fibers are derived from fossil fuels and are non-renewable.

Preparing shaped articles from polyurethanes using a melt processing technique has long been desired. Such processes have been developed (see, e.g., “Chemical Fibers International”, Vol. 51, pages 46-48), but industry desires better properties and products from renewable resources.

Polyurethane prepared using polytrimethylene ether glycol (PO3G) to form the soft segment are disclosed in U.S. Pat. Nos. 6,852,823 and 6,946,539, both of which are incorporated herein by reference. PO3G can be prepared from 1,3-propaneiol, which in turn can be prepared from renewable resources, such as corn and other crops. These polyurethanes can be used to make melt processed articles. The disclosed polyurethanes can be melt-processed to make fibers, films, and other products. There is still a desire for polyurethanes that can be more easily extruded.

### SUMMARY OF THE INVENTION

The invention is directed to a thermoplastic polyurethane prepared from reactants comprising: (a) polytrimethylene ether glycol; (b) diisocyanate; (c) diol chain extender; and (d) monofunctional alcohol chain terminator or monofunctional amine chain terminator. The thermoplastic polyurethane can contain monofunctional alcohol chain terminator, monofunctional amine chain terminator, or both types of chain terminator.

Preferably the diol chain extender is selected from the group consisting of ethylene glycol, 1,2-propylene glycol, 1,3-propanediol, 1,4-butanediol, 1,6-hexanediol, diethylene glycol, 2-methyl-1,3-propanediol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, bis(hydroxyethylene)terephthalate, hydroquinone bis(2-hydroxyethyl)ether, and mixtures thereof.

In one preferred embodiment, the diol chain extender consists essentially of a single diol. In another preferred embodiment, diol chain extender comprises a mixture of two or more diols.

Preferably the diisocyanate is selected from the group consisting of 2,4-toluene diisocyanate, 2,6-toluene diisocyanate, 4,4′-diphenylmethane diisocyanate, 4,4′-dicyclohexylmethane diisocyanate, 3,3′-dimethyl-4,4′-biphenyl diisocyanate, 1,4-benzene diisocyanate, cyclohexane-1,4-diisocyanate, 1,5-naphthalene diisocyanate, 1,6-hexamethylene diisocyanate, 4,6-xylyene diisocyanate, isophorone diisocyanate, and mixtures thereof.

Preferably the monofunctional alcohol or amine chain terminator is a monofunctional alcohol, preferably selected from the group consisting of n-butanol, n-hexanol, n-octanol, n-decanol, n-dodecanol and mixtures thereof.

Preferably the monofunctional alcohol or amine chain terminator is a monofunctional amine, preferably selected from the group consisting of ethyl amine, propylamine, butyl amine, octyl amine, stearyl amine and mixtures thereof.

Preferably the ratio of total hydroxyl and amine groups contained in the polytrimethylene ether glycol, diol chain extenders and monofunctional alcohol or amine chain terminators to isocyanate groups in the diisocyanate is about 1:0.95 to about 1:1.1, more preferably 1:0.98 to 1:1.05.

In a preferred embodiment, the polytrimethylene ether glycol is produced from ingredients comprising 1,3-propanediol derived from a fermentation process using a renewable biological source.

In one preferred embodiment, the polytrimethylene ether glycol is blended with up to about 50 wt. %, by weight of the total polymeric glycols, of other polymeric glycols, preferably selected from the group consisting of hydroxyl terminated polyether glycols, polyester glycols, polycarbonate glycols and silicone glycols, More preferably the other polymeric glycols are polyether glycols selected from the group consisting of homo or copolyethers of polyethylene glycol, poly(1,2-propylene glycol), polytetramethylene ether glycol and mixtures thereof. Preferably the other polymeric glycols are used in an amount of up to about 25 weight %. In another preferred embodiment, the polytrimethylene ether glycol is not blended with other polymeric glycols.

Preferably the polytrimethylene ether glycol has a number average molecular weight in the range of about 500 to about 5,000.

Preferably the polytrimethylene ether glycol has unsaturated end groups in the range of about 0.003 to about 0.03 meq/g.

In one preferred embodiment, the polytrimethylene ether glycol comprises a blend of polytrimethylene ether glycol having a number average molecular weight of from about 1,000 to about 5,000 and polytrimethylene ether glycol having a number average molecular weight of from about 200 to about 750.

Preferably about 75 to 100 mole %, more preferably about 90 to 100 mole %, and most preferably about 99 to 100 mole %, of the repeat units of the polytrimethylene ether glycol are trimethylene ether units.

The diol chain extender and the diisocyanate form the hard segment of the polyurethane composition. The polytrimethylene ether glycol forms the soft segment of the polyurethane composition. Depending on the end use applications, compositions of the present invention preferably has hard segments of from about 20 to about 80% and soft segment of from about 80 to about 20%, both by weight of the total weight of the polyurethane. The preferred polyurethane for fiber end uses include hard segments of about 20 to about 40%, with soft segment of about 80 to about 60%, and the preferred polyurethane for film end uses include hard segments of about 30 to about 60%, with soft segment of about 70 to about 40%, all by weight of the polyurethane.

The invention is also directed to a thermoplastic polyurethane comprising: (a) 80 to 20 weight %, by weight of the thermoplastic polyurethane, soft segment containing repeat units from polytrimethylene ether glycol; (b) 20 to 80 weight %, by weight of the thermoplastic polyurethane, hard segment comprising repeating units from diisocyanate and from diol chain extender; and (c) chain termination units from monofunctional alcohol chain terminator or monofunctional amine chain terminator. Preferably the ratio of total hydroxyl and amine groups contained in the polytrimethylene ether glycol, diol chain extenders and monofunctional alcohol or amine chain terminators to isocyanate groups in the diisocyanate is from about 1:0.95 to about 1:1.1. In one preferred embodiment, the thermoplastic polyurethane comprises 80 to 60 weight % soft segment and 20 to 40 weight %, hard segment. In another preferred embodiment, the thermoplastic polyurethane comprises 70 to 40 weight % soft segment and 30 to 60 weight %, hard segment.

The invention is further directed to a process of producing thermoplastic polyurethane comprising: (a) reacting diisocyanate and polytrimethylene ether glycol while maintaining an NCO:OH equivalent ratio of about 1.1:1 to about 10:1 to form diisocyanate-terminated polytrimethylene ether-urethane prepolymer; and (b) reacting the diisocyanate-terminated polytrimethylene ether-urethane prepolymer with diol chain extender and monofunctional alcohol or amine chain terminator. Preferably the ratio of total hydroxyl and amine groups contained in the polytrimethylene ether glycol, diol chain extenders and monofunctional alcohol or amine chain terminators to isocyanate groups in the diisocyanate is about 1:0.95 to about 1:1.1. Preferably this process is performed in an extruder at a temperature of from about 100° C. to about 220° C.

In addition, the invention is directed to a process of producing thermoplastic polyurethane comprising: (a) providing (i) diisocyanate, (ii) polytrimethylene ether glycol, (iii) diol chain extender; and (iv) monofunctional alcohol or amine chain terminator; and (b) reacting the diisocyanate, the polytrimethylene ether glycol, the diol chain extender and the monofunctional alcohol or amine chain terminator. Preferably the ratio of total hydroxyl and amine groups contained in the polytrimethylene ether glycol, diol chain extenders and monofunctional alcohol or amine chain terminators to isocyanate groups in the diisocyanate is about 1:0.95 to about 1:1.1.

Further, the invention is directed to a shaped article comprising the thermoplastic polyurethane. Preferably the shaped article is selected from the group consisting of fibers, films, sheets, hoses, tubing, wire and cable jackets, shoe soles, air bag bladders and medical devices.

One preferred embodiment is directed to a melt spun fiber. Preferably the fiber is a monofilament or multifilament fiber. Preferably the fiber is selected from the group consisting of continuous filament or staple fiber. The invention is also directed to a woven or knit fabric comprising the fiber.

Another preferred embodiment is directed to a film comprising the thermoplastic polyurethane. Preferably the thickness of the film is from about 5 μm to 500 μm.

The thermoplastic polyurethanes films are useful as water vapor permeable materials, particularly those where high breathability to water vapor are vital. Thus, a further preferred embodiment is a water vapor permeable membrane. They are useful for many purposes, such as for wound dressings, burn dressings, surgical drapes, surgical sutures and the like, and the invention is also directed to the processes of use. Preferably the polyurethane membrane has a water vapor permeability rate of at least about 2500 mil-gm/m²/day, more preferably about 2,500 to about 10,000, and most preferably about 3,000 to about 6,000. The invention is even further directed to a water impermeable, water vapor permeable fabric comprising a variety of substrates including natural or synthetic wovens or non-wovens (e.g., polyester, polyamide, cotton, wool, etc.). The polyurethane films can be laminated on a substrate with adhesives or by bonding directly.

The invention is also directed to a process of forming a shaped article comprising providing the thermoplastic polyurethane and melt processing the thermoplastic polyurethane to form a shaped article. Preferred shaped articles are described above, and include fibers. Thus, the invention is directed to a process of forming a fiber comprising providing the thermoplastic polyurethane and melt spinning the thermoplastic polyurethane into a fiber. In one preferred embodiment, the thermoplastic polyurethane is spun into fiber from the melt in the absence of solvent.

In a preferred embodiment of melt spinning the polyurethane from a spinneret to form a fiber the process further comprising the steps: (c) drawing the fiber and (d) winding the fiber on bobbins. The invention is also directed to a woven or knit fabric comprising the fibers prepared by these methods.

The invention provides polyurethane elastomeric compositions that can be derived from bio-based ingredients that are environmentally friendly and suitable to produce shaped articles, such as thermoplastic elastic fibers in a solvent-free, environmentally friendly process, films, etc. The many advantages of this invention are described throughout this document.

### DETAILED DESCRIPTION OF THE INVENTION

All publications, patent applications, patents, and other references mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

The materials, methods, and examples herein are illustrative only and, except as specifically stated, are not intended to be limiting. Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

The invention is directed to a thermoplastic polyurethane prepared from reactants comprising: (a) polytrimethylene ether glycol; (b) diisocyanate; (c) diol chain extender; and (d) monofunctional alcohol chain terminator or monofunctional amine chain terminator. The thermoplastic polyurethane can contain monofunctional alcohol chain terminator, monofunctional amine chain terminator, or both types of chain terminator.

In the polyurethanes, soft segments form primarily from the polytrimethylene ether glycol and hard segments form primarily from the polyisocyanate and chain extenders (the hydroxyl at the ends of the polytrimethylene ether glycols are considered to form part of the hard segment).

The polytrimethylene ether glycols for use in this invention are prepared by the acid-catalyzed polycondensation of 1,3-propanediol reactant, preferably as described in U.S. 2002/007043 A1, 2005/0020805 A1, U.S. Pat. No. 6,720,459, and U.S. patent application Ser. Nos. 10/871,622, filed Jun. 18, 2004, 11/204,713, filed Aug. 16, 2005, and 11/204,731, filed Aug. 16, 2005, all of which are incorporated herein by reference. By “1,3-propanediol reactant” is meant 1,3-propanediol, its dimers and trimers, and mixtures thereof.

Preferably, the polytrimethylene ether glycols after purification have essentially no acid end groups, but they do contain unsaturated end groups, predominately allyl end groups, in the range of about 0.003 to about 0.03 meq/g. The small number of allyl end groups in the polytrimethylene ether glycols are useful to control polyurethane molecular weight and surface characteristics, while not unduly restricting it, so that elastomers ideally suited for fiber and other end-uses can be prepared. Thus, the polytrimethylene ether glycols can be considered to consist essentially of the compounds having the following formulae:
HO—((CH₂)₃O)ₘ—H (I)
HO—((CH₂)₃—O)ₘCH₂CH═CH₂ (II)
wherein m is in a range such that the Mₙ is within the aforementioned Mₙ range with compounds of formula (II) being present in an amount such that the allyl end groups (preferably all unsaturation ends or end groups) are present in the range of about 0.003 to about 0.03 meq/g.

The polytrimethylene ether glycol preferably has trimethylene ether units as about 50 to 100 mole percent, more preferably from about 75 to 100 mole percent, even more preferably from about 90 to 100 mole percent, and most preferably from about 99 to 100 mole percent of the repeating units.

Polytrimethylene polyether glycols are preferably prepared by polycondensation of monomers comprising 1,3-propanediol, thus resulting in polymers or copolymers containing trimethylene ether repeating units. As indicated above, at least 50% of the repeating units are trimethylene ether units. Thus, minor amounts of other polyalkylene ether repeating units may be present also. Preferably these are derived from aliphatic diols other than 1,3-propanediol. Examples of typical aliphatic diols from which polyalkylene ether repeating units may be derived include those derived from aliphatic diols, for example ethylene glycol, 1,6-hexanediol, 1,7-heptanediol, 1,8-octanediol, 1,9-nonanediol, 1,10-decanediol, 1,12-dodecanediol, 3,3,4,4,5,5-hexafluoro-1,5-pentanediol-, 2,2,3,3,4,4,5,5-octafluoro-1,6-hexanediol, and 3,3,4,4,5,5,6,6,7,7,8,8,9,9,10,10-hexadecafluoro-1,12-dodecanediol, cycloaliphatic diols, for example 1,4 cyclohexanediol, 1,4-cyclohexanedimethanol and isosorbide. A preferred group of aliphatic diols is selected from the group consisting of ethylene glycol, 2-methyl-1,3-propanediol, 2,2-dimethyl-1,3-propanediol, 2,2-diethyl-1,3-propanediol, 2-ethyl-2-(hydroxymethyl)-1,3-propanediol, 1,6-hexanediol, 1,8-octanediol, 1,10-decanediol, isosorbide, and mixtures thereof. The most preferred diol other than 1,3-propanediol is ethylene glycol.

The 1,3-propanediol employed for preparing the polytrimethylene ether glycols can be obtained by any of the various chemical routes or by biochemical transformation routes. Preferred routes are described in U.S. Pat. Nos. 5,015,789, 5,276,201, 5,284,979, 5,334,778, 5,364,984, 5,364,987, 5,633,362, 5,686,276, 5,821,092, 5,962,745, 6,140,543, 6,232,511, 6,235,948, 6,277,289, 6,297,408, 6,331,264 and 6,342,646, U.S. Pat. Nos. 5,633,362, 5,686,276, and 5,821,092, and U.S. Patent Application Publication Nos. 2004/0225161; 2004/0260125, 2004/0225162, and US 2005-0069997 A1, all of which are incorporated herein by reference in their entireties. The most preferred 1,3-propanediol is prepared by a fermentation process using a renewable biological source. Preferably the 1,3-propanediol used as the reactant or as a component of the reactant will have a purity of greater than about 99% by weight as determined by gas chromatographic analysis.

The polytrimethylene ether glycols for use in the invention have a number average molecular weight (Mₙ) in the range of about 500 to about 5,000. Blends of polytrimethylene ether glycols can also be used. For example, the polytrimethylene ether glycol can comprise a blend of a higher and a lower molecular weight polytrimethylene ether glycol, preferably wherein the higher molecular weight polytrimethylene ether glycol has a number average molecular weight of 1,000 to 5,000 and the lower molecular weight polytrimethylene ether glycol has a number average molecular weight of 200 to 750. The Mₙ of the blended polytrimethylene ether glycols should still be in the range of about 500 to about 5,000. The polydispersity (i.e. M_{w}/Mₙ) of the polytrimethylene ether glycol is preferably within the range of 1.5 to 2.1. The polydispersity can be adjusted by using blends of polytrimethylene ether glycols.

In one embodiment, the polytrimethylene ether glycol may be blended with other polymer diols selected from the group of polyether diols, polyester diols, polycarbonate diols, polyolefin diols and silicone diols. Mixtures of polymeric diol provide polyurethanes with very useful combinations of properties. In this embodiment, the polytrimethylene ether glycol is preferably blended with up to about 50 weight %, more preferably up to about 25 weight %, and most preferably up to about 10 weight %, of the other polymer diols.

Preferred polyether diols for blending with polytrimethylene ether glycol are polyethylene glycol, poly(1,2-propylene glycol), polytetramethylene glycol, copolyethers such as tetrahydrofuran/ethylene oxide and tetrahydrofuran/propylene oxide copolymers, and mixtures thereof.

Preferable polyester diols for blending with polytrimethylene ether glycol are hydroxyl terminated poly(butylene adipate), poly(butylene succinate) poly(ethylene adipate), poly(1,2-proylene adipate), poly(trimethylene adipate), poly(trimethylene succinate) polylactic acid ester diol, and polycaprolactone diol. Other diols useful for blending include polycarbonate diols, polyolefin diols and silicone glycols. Preferable polycarbonate diols for blending with polytrimethylene ether glycol are selected from the group consisting of polyethylene carbonate diol, polytrimethylene carbonate diol, and polybutylene carbonate diol. Polyolefin diols are available from Shell as KRATON LIQUID L and Mitsubishi Chemical as POLYTAIL H. Silicone glycols are well known, and representative examples are described in U.S. Pat. No. 4,647,643, which is incorporated herein by reference.

Any diisocyanate useful in preparing polyurethanes from polyether glycols, diisocyanates and diols or amine can be used in this invention. They include, but are not limited to, 2,4-toluene diisocyanate, 2,6-toluene diisocyanate (“TDI”), 4,4′-diphenylmethane diisocyanater (“MDI”), 4,4′-dicyclohexylmethane diisocyanate (“H12MDI”), 3,3′-dimethyl-4,4′-biphenyl diisocyanate (“TODI”), 1,4-benzene diisocyanate, cyclohexane-1,4-diisocyanate, 1,5-naphthalene diisocyanate (“NDI”), 1,6-hexamethylene diisocyanate (“HDI”), 4,6-xylyene diisocyanate, isophorone diisocyanate (“IPDI”), and combinations thereof. MDI, HDI, and TDI are preferred.

Small amounts, preferably less than about 10 wt. % based on the weight of the diisocyante, of monoisocyanates or polyisocyanates can be used in mixture with the diisocyanate.

The function of a diol chain extender is to increase the molecular weight of the polyurethanes. Any diol chain extender useful in preparing polyurethanes can be used in this invention. The diols may be either aromatic or aliphatic, linear or branched. Diol chain extenders useful in making the polyurethanes of the invention preferably have an average molecular weight in the range from 60 to about 600. They include, but are not restricted to ethylene glycol, 1,2-propylene glycol, 1,3-propanediol, 1,4-butanediol, 1,6-hexanediol, diethylene glycol, 2-methyl-1,3-propanediol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, bis(hydroxyethylene)terephthalate, hydroquinone bis(2-hydroxyethyl)ether, cyclohexane dimethanol, bis(2-hydroxyethyl) bisphenol A, and mixtures thereof. The diols also include glycol ethers such as diethylene glycol, triethylene glycol, dipropylene glycol, and tripropylene glycol. Preferred diol chain extenders are ethylene glycol, 1,3-propanediol, 1,4-butanediol, 1,6-hexanediol, and 2-methyl-1,3-propanediol.

The diol chain extender and the diisocyanate make up the hard segment of the polyurethane composition. Depending on the end use applications, compositions of the present invention may have hard segments of from 20 to 80% by weight of the total weight of the polymer. The preferred composition f for fiber end use include hard segments of 20 to 40% and the preferred composition for film end use include hard segments of 30-60% by weight.

In order to control crystallization of the polyurethane, it may be advantageous to use a mixture of two or more, preferably two, diol chain extenders. In this case the chain extender mixture preferably will consist of 85 to 99% by weight, preferably 90 to 98% by weight and most preferably, 92 to 95% by weight of one diol, the primary diol, and of 1 to 15% by weight, preferably 2 to 10% by weight and most preferably, 5 to 8% by weight of another, or mixture of other, secondary diol. The most preferred primary diol is 1,4-butanediol. Preferred secondary diols are any of those in the list above.

The chain terminators used in the present invention are monofunctional alcohol or monofunctional amine. Either or both can be used. They control the molecular weight of the polyurethanes and aid in achieving improved extrudability and spinnability.

The preferred chain terminators are monoalcohols. Monoalcohols for use as chain terminators are preferably C₂-C₁₈ alkyl alcohols such as n-butanol, n-octanol, and n-decanol, n-dodecanol, stearyl alcohol and C₂-C₁₂ fluorinated alcohols, and more preferably C₃-C₆ alkyl alcohols such as n-propanol, n-butanol, and n-hexanol.

Monoamines are also preferred chain terminators. Any monoamine reactive with isocyanates can be used as chain terminators. Preferred monoamines are the primary and secondary monoamines. Aliphatic primary or secondary monoamines are more preferred. Example of monoamines useful as chain terminators include but are not restricted to ethylamine, propylamine, butylamine, hexylamine, 2-ethylhexylamine, dodecylamine, stearylamine, dibutylamine, dinonylamine, bis(2-ethylhexyl)amine, bis(methoxyethyl)amine, and n-methylstearylamine

It should be noted that in this invention when monofunctional amines are used as chain terminator that result in a polymer with urea end groups. This contrasts with the formation of polyurethane-ureas which contain urea linkages throughout chain using a diamine. Thus, the invention is directed to preparing compositions that are called “polyurethanes”, not “polyurethane-ureas.”

In a preferred embodiment, the thermoplastic polyurethanes of the invention are prepared from one or more renewable ingredients. Examples of such bio-based ingredients include, but are not limited to, polytrimethylene ether glycols prepared from 1,3-propanediol, polytrimethylene ether ester diol, polytrimethylene succinate diol, polybutylene succinate diol and vegetable-based polyols such as soy polyols and castor polyols. Bio-based chain extenders include 1,3-propanediol, 1,4-butanediol, and ethylene glycol.

Other additives of the types generally used in industry can be used. Useful additives include polyhydroxy functional branching agents, mold release agents (e.g. silicones, fluoroplastics, fatty acid esters), minerals and nanocomposites for reinforcement (e.g. mica, organic fibers, glass fibers, etc.) delusterants (e.g., TiO₂, zinc sulfide or zinc oxide), colorants (e.g., dyes), stabilizers (e.g., antioxidants (e.g., hindered phenols and amines), ultraviolet light stabilizers, heat stabilizers, etc.), plasticizers, fillers, flame-retardants, pigments, antimicrobial agents, antistatic agents, optical brightners, processing aids, viscosity boosters, and other functional additives. As a specific example, polytrimethylene ether glycols are subject to oxidation during storage and a preferred antioxidant stabilizer is commonly known as butylated hydroxy toluene or BHT, used at a level of 50 to 500 micrograms/g based on the weight of the polytrimethylene ether glycol. The most preferred level is about 100 micrograms/g.

The polyurethanes of the invention can be prepared by one-shot or multiple-shot methods, preferably by a multiple-shot methods. Batch, semi-continuous, and continuous reactors can be employed.

In the one-shot process, polyurethane is prepared by (a) providing (i) the diisocyanate, (ii) the polytrimethylene ether glycol, (iii) a diol or a blend of two or more diol chain extenders, and (iv) a monofunctional chain terminator; and reacting all the ingredients to form the polyurethane in one step. They are preferably reacted at about 40 to about 120° C., most preferably at about 80 to about 100° C. Preferably the ratio of isocyanate groups to the sum of isocyanate reactive groups, i.e., hydroxyl and amine groups, is close to 1:1 for optimum results. If this ratio is less than about 0.95:1 the molecular weight of the resulting polymers is lower than desired. On the other hand, if the ratio is above 1.1:1 crosslinking can occur. The preferred ratio is about 0.98:1 to 1.05:1 for thermoplastic, melt-spinnable polyurethanes.

In the multi-shot method, a diisocyanate-terminated polytrimethylene ether-urethane prepolymer is produced by reacting diisocyanate and polytrimethylene ether glycol while maintaining an NCO:OH equivalent ratio of about 1.1:1 to about 10:1, preferably at least about 1.5:1, more preferably at least about 1.6:1, most preferably at least about 2:1, and preferably up to about 8:1, preferably at a temperature of about 40° C. to about 120° C., more preferably about 50° C. to about 100° C., to form the prepolymer. Then, the diisocyanate-terminated prepolymer and the diol chain extender and chain terminator are carried out.

The prepolymer of this embodiment is stable and can be transported or moved to another location prior to reaction with diol chain extender and chain terminator. Alternatively, the reaction with diol chain extender and chain terminator can be carried out immediately. When diol chain extender and chain terminator are added together, this is carried out while maintaining an amine plus hydroxyl to isocyanate equivalent ratio of about 1:0.95 to about 1:1.1. According to a preferred process the prepolymer is heated to about 60-70° C., mixed thoroughly with a high-speed mixer with the diol(s) chain extender and the chain terminator. After mixing, the reaction is completed by heating at about 800 to about 100° C. Alternatively, the chain extender can be added first and then the chain terminator can be added at the end of the polymerization.

Polyurethane that has been thus prepared can be processed into chips, flakes, pellets and the like. Generally the chips or pellets are dried by any conventional drying methods before further use.

The polyurethane compositions of the present invention can be made continuously by reaction in an extruder, preferably in a single or twin-screw extruder. Extruder reaction processes are known in the art and are described in U.S. Pat. Nos. 4,245,081 and 4,371,684, which are incorporated here by reference. The reaction temperature in the extruder is generally in the range from about 60 to 275° C., preferably in reaction zones that increase in temperature so as to build MW, and the residence times of the reaction melt in the screw extruder are generally from about 0.5 to 30 minutes. Each of the ingredients can be fed separately, or one or more can be fed together. However, at least two feeds should be used, and in the event only two feed streams are used one stream should contain the (i) polytrimethylene ether glycol, (ii) diol chain extender, and (iii) chain terminator and the other stream should contain the diisocyanate. Both the one-shot and multi-shot reactions described above are carried out in the extruder to make polyurethane prepolymers and final polymers and the resulting polytrimethylene ether urethanes are made into chips, flakes or pellets or processed directly either by melt or solution to make various shaped articles.

Catalysts are not necessary to prepare the polyurethanes, but may provide advantages in their manufacture. The catalysts most widely used are tertiary amines and organo-tin compounds such as stannous octoate, dibutyltin dioctoate, dibutyltin dilaurate, and they can be used either in the one-shot process, to make prepolymers, or in making polyurethanes from prepolymers.

Additives can be incorporated into the polytrimethylene ether glycol, the prepolymer, or the polyurethane by known techniques. Useful additives include polyhydroxy functional branching agents (e.g., glycerin, trimethylolpropane, hexanetriol, pentaerythritol), delusterants (e.g., TiO₂, zinc sulfide or zinc oxide), colorants (e.g., dyes), stabilizers (e.g., antioxidants (e.g., hindered phenols and amines such as those sold as IRGANOX, ETHANOX, LOWINOX), ultraviolet light stabilizers (e.g., TINUVIN 368, TINUVIN 765), heat stabilizers, etc., fillers, flame retardants, pigments, antimicrobial agents, antistatic agents, optical brightners, viscosity boosters, lubricating agents, antiblocking agents/extrusion processing aids (e.g. ACRAWAX C, GLYCOLUBE VL) and other functional additives.

The polyurethane elastomers of the invention are processable by melt or solution casting, melt extrusion and/or calendering, injection molding and blow molding to form melt spun fibers, films or sheets, hoses and tubings, wire and cable jacketing, shoe soles, air bag bladders, medical devices, and like. The most preferable use of the invention is in melt-spun elastic fibers and fabrics. The elastic fibers produced include mono or multifilaments and can be continuous filaments or staple fiber. The fibers are used to prepare woven, knit and nonwoven fabric. The nonwoven fabrics can be prepared using conventional techniques such as those used for meltblown, spunbonded and card and bond fabrics, including heat bonding (hot air and point bonding), air entanglement, etc. Melt-spun thermoplastic polyurethane fibers of the present invention can be combined with other natural and synthetic fibers to making clothing.

Melt spun fibers can be made from polymer compositions prepared by any of the polymerization methods described above.

The thermoplastic polyurethane of the invention can be spun into fibers by conventional techniques involving melt spinning the polyurethane from a spinneret to form a fiber, optionally heating and drawing the fiber, and winding the fiber on bobbins. The cross-section of the fiber of can be round or of any other suitable cross-section.

The melt-spun thermoplastic polyurethane can be spun as single filaments or can be coalesced by conventional techniques into multi-filament yarns. Each filament can be made in a variety of denier. Denier is a term in the art designating the fiber size. Denier is the weight in grams of 9000 meters of fiber. The fibers are preferably at least about 5 denier, and preferably are up to about 2000 denier, more preferably up to about 1200 denier, and most preferably less than 250 denier.

Spinning speeds can be at least about 100 meters per minute (mpm), more preferably at least about 1,000 mpm and can be up to 5,000 mpm or higher.

The fibers can be drawn from about 1.5× to about 8×, preferably at least about 2× and preferably up to about 4×. Single step draw is the preferred drawing technique. In most cases it is preferred not to draw fibers.

The fibers can be heat set, and preferably the heat setting temperature is at least about 100° C. and preferably up to about 175° C.

Finishes can be applied to the fibers for spinning or subsequent processing, and include silicone oil, mineral oil and other spin finishes used for polyesters, spandex elastomers, etc.

The fibers are stretchable, have good chlorine resistance, can be dyed under normal polyester dyeing conditions, and have excellent physical properties, including superior strength and stretch recovery properties, particularly stress decay.

To reduce tackiness certain additives can be introduced into the fibers. These additives include silicon oil, metal stearates such as calcium stearate, sodium stearate, magnesium stearate, talc and barium sulfate and the like. In addition, various finishes have been suggested for lubricating the surfaces of the fibers and thus reducing their tackiness. The fibers thus produced can be processed further, for example, wet dyeing at about 100° C.

Melt-spun fibers of the present invention have many advantages. For example, no solvent is needed either when making polymer compositions or during the actual spinning process, and therefore the final fibers contain no solvent residuals. As a result, the melt spinning process is free of pollution, has reduced production costs—low energy consumption, simple building requirements and minimal labor requirements. In contrast, the solution dry spinning process is very expensive and complicated and requires solvent during polymerization and spinning processes. Solvent must be recovered which means that the installation and operation costs are high. Furthermore, the major ingredient of the present invention composition is polytrimethylene ether glycol, which is prepared from bio-based diol (i.e., 1-3-propanediol prepared by fermentation from carbohydrate (e.g., sugar)) and thus the melt-spun polyurethanes are “greener” than current polyurethanes.

Films and sheets can be prepared using polymer compositions made by any of the previously described processes, preferably from the one-shot polymerization method. Films can be made by melt-extrusion, blowing, extrusion casting, solution casting, or by calendering, preferably by extrusion casting. To cast the films from solution, the polymer should be dissolved in an appropriate solvent such as dimethylformamide, dimethylacetamide, and tetrahydrofuran. The resulting solution is casted onto a support according to conventional procedure to obtain films upon evaporation of the solvent. When melt-extruded to form films, the polymer is dried first and extruded in an ordinary commercial twin-screw extruder to melt the resin and make the melt homogeneous. The polymer melt is pumped through a filter media with a fine mesh (for example, 70μ filter mesh) to permit further processing. The polymer is then extruded through a conventional “coat hanger” style cast film die. The polymer is cast on a conventional cold quench roll (e.g., water-cooled spiral channels) at temperatures of from about 15 to about 25° C. The properties of the films thus made are tested.

The thickness of the film can vary, depending upon the intended use for the film. For example, thicker films, e.g., having thicknesses of about 1 mm or thicker, may be preferred for some uses. In some embodiments, the film has a thickness of 500 micrometers or less. In some embodiments, the film has a thickness of 100 micrometers or less. In other embodiments, the film has a thickness of 50 micrometers or less. Generally, the film has a thickness of about 5 micrometers or more, in some embodiments about 10 micrometers or more, often about 20 micrometers or more. Thinner films, i.e., having thicknesses of 5-25 micrometers, may be preferred for use as moisture barriers.

The flexible polyurethane films of the present invention are also useful as semi-permeable membranes and preferably useful as moisture or water vapor permeable membranes, such as those used in wound dressings, burn dressings, surgical drapes, and. The water vapor transmission or permeable rate (WVTR) of films determines how breathable the films are to water vapor. Water vapor permeability is measured according to ASTM F1249. The WVTR is calculated by measuring how many grams of water in vapor form go through one square meter of film in 24 hours (h) and expressed in units of gm/(m²-24 h). The WVTR of the film is primarily dependent upon its chemical composition and thickness. Preferably the polyurethane membrane has a water vapor permeability rate of at least about 2500 mil-gm/m²/day, more preferably about 2,500 to about 10,000, and most preferably about 3000 to about 6000.

The polyurethanes can be used as pure films or applied onto textile fabrics including natural or synthetic wovens or non-wovens by either lamination using adhesives or by coating. The invention is even further directed to a water impermeable, water vapor permeable fabric comprising a substrate and the polyurethane film.

The polyurethane films or fabrics that are breathable to water vapor can be used in healthcare, construction, agriculture and food packaging industries, such as the type described in U.S. Pat. No. 5,120,813 (which is incorporated herein by reference). The films of the present invention are useful wherever water impermeability and water vapor permeability are desired, for example as rainwear or shoe tops uses. The polyurethane films of this invention surprisingly have low water absorption, excellent mechanical, elastic and breathable properties, and thus ideally suitable where dimensional stability is an issue. The films of the present invention are non-porous membranes.

In addition, the water vapor transmission rate of the present films can be enhanced further by making polyurethane films from the blends of polytrimethylene ether glycol and polyethylene glycol. Additives for example inorganic salts such as lithium bromide can be added to enhance the moisture vapor transmission rates.

The following examples are presented for the purpose of illustrating the invention, and are not intended to be limiting. All parts, percentages, etc., are by weight unless otherwise indicated.

### EXAMPLES

The 1,3-propanediol utilized in the examples was prepared by biological methods described in U.S. Patent Application Publication No. 2005/0069997, which is incorporated herein by reference, and had a purity of >99.8%.

Test Methods

Number-average molecular weights (Mₙ) of polytrimethylene ether glycol were calculated from the hydroxyl number, which was determined according to ASTM E222 method. Number-average molecular weight and weight-average molecular weight of polyurethane polymers were measured by gel permeation chromatography (GPC).

Melting Point (Tₘ), Crystallization Temperature (Tc) and glass transition temperature (Tg) were determined using the procedure of the American Society for Testing Materials ASTM D-3418 (1988) using a DuPont DSC Instrument Model 2100 (E.I. du Pont de Nemours and Co., Wilmington, Del.). The heating and cooling rates were 10° C. per minute.

Water absorption of polyurethane films is measured according to ASTM D570, which is hereby incorporated by reference. The water vapor transmission rate through the films using a modulated infrared sensor was measured according to ASTM F1249 and this method is applicable to films up to 0.1 inch in thickness.

Water vapor permeability is measured according to ASTM F1249.

Fiber Spinning Methods

Melt Spinning Elastic Fiber from a Small Scale Press Spin Unit

To perform the melt spinning, a cylindrical cell of 2.2 cm inside diameter and 12.7 cm length was employed. The cell was equipped with a hydraulically driven ram that was inserted on top of the sample. The ram had a replaceable TEFLON® tip designed to fit snugly inside the cell. An annular electric heater which surrounded the lower quarter of the cell was used for controlling cell temperature. A thermocouple inside the cell heater recorded the cell temperature. Attached to the bottom of the cell was a spinneret, the interior of which included a cylindrical passage, measuring 1.27 cm in diameter with a 0.64 cm cell cavity. The spinneret cavity contained stainless steel filters of the following mesh, inserted in the following order, starting from the bottom (i.e., closest to the exit): 50, 50, 325, 50, 200, 50, 100, 50. A compressible annular aluminum seal was fitted to the top of the “stack” of filters. Below the filters was a cylindrical passage of about 2.5 cm length and 0.16 cm interior diameter, the lower of which was tapered (at an angle of 60 degrees from the vertical) to meet with an outlet orifice measuring 0.069 cm in length and 0.023 cm inside diameter. The spinneret temperature was controlled by a separate annular heater. The exiting filament was wrapped around a set of feed rolls operated at 40 meters/minutes followed by a set of draw rolls operated at 160 meters/minute (4× draw ratio), and then delivered to the final package. The ratio of the speed of the draw roll to the feed roll defines the draw ratio.

The polymer was dried before being transferred to the extruder. Physical properties reported herein are for fibers spun at different draw ratios.

Melt Spinning of Elastic Fiber from a Semi-Industrial Scale Spin Unit (Position a Spinning Machine)

The spinning conditions were as follows. Fibers were melt spun on 28 MM twin screw extruder (Werner & Pfleiderer Corporation, Ramsey, N.J.). The screw speed of the extruder was about 25 rpm. The flow of the polymer melt through the extruder was approximately 13 g/min. A spinneret with 13 holes having dimensions 0.009×0.012 inches was used. A filter having 25/50 mesh was placed before the spinneret. To avoid sticking of the fibers, a finish was spread on the fibers through a syringe pump at the rate of 0.2 ml/min. The spinning was done at a spinning temperature of 230° C., and the fiber was wound at winding speeds ranging from 750 to 1000 mpm.

Fiber Properties

Fiber Tenacity and Elongation

Tenacity at break, T, in grams per denier (gpd) and percent elongation at break, E, were measured on an Instron.RTM Tester equipped with a Series 2712 (002) Pneumatic Action Grips equipped with acrylic contact faces. The test was repeated three times and then the average of the results is reported.

The average denier for the fibers used in the tenacity and elongation measurements is reported as Den 1.

Fiber Unload Power, Stress Decay and Percent Set

The average denier for the fibers used in measuring unload power, stress decay and percent set is reported as Den 2.

Unload power (TM1) was measured in gram per denier. One filament, a 2 inch (5 cm) gauge length, was used for each determination. Separate measurements were made using zero-to-300% elongation cycles. Unload power (i.e., the stress at a particular elongation) was measured after the samples have been cycled five times at a constant elongation rate of 1000% per minute and then held at 100% or 300% extension for half a minute after the fifth extension. While unloading from this last extension, the stress, or unload power, was measured at various elongations.

Stress Decay was measured as the percent loss of stress on a fiber over a 30 second period with the sample held at 100 or 300% extension at the end of the fifth load cycle.

S=((F−C)*100)/F where:

S=Stress Decay, %

F=Stress at full extension

C=Stress after 30 seconds

The percent set was measured from the stress/strain curve recorded on chart paper.

### Example 1

This example illustrates the preparation of a diisocyanate-terminated polytrimethylene ether-urethane prepolymer.

The prepolymer was prepared as follows. Polytrimethylene ether glycol (2.885 kg) of number average molecular weight 2,000 was dried to a moisture content less than 500 ppm and then charged to a 5-L four-necked flask equipped with a mechanical stirrer, addition funnel, thermocouple, and a gas inlet adapter. IRGANOX 1098 antioxidant (2.3 g) (Ciba Specialty Chemicals, Tarrytown, N.Y.) was added to the glycol and allowed to mix completely. The mixture was then heated to 60 oC under an inert nitrogen atmosphere. Molten (50° C.) 4,4′-diphenyl methane diisocyanate (ISONATE 125M, Dow Chemical Company, Midland, Mich.) (1.665 kg) was added slowly to the mixture at a rate sufficient to maintain a reaction temperature of <70° C. The reactor temperature was held at 70 o to about 80° C. until the NCO:OH reaction was complete. The prepolymer product was degassed and transferred hot to a clean dry plastic container and sealed under a nitrogen atmosphere until tested or used.

### Example 2

This example is a control example illustrating preparation of polyurethane utilizing the prepolymer prepared in Example 1 and a diol chain extender, but no monofunctional chain terminator.

An aliquot (800 g) of diisocyanate-terminated polytrimethylene ether-urethane prepolymer made in Example 1 was transferred to another reactor and held at 60° C. Preheated 1,4-butanediol (78 g) was added to the prepolymer. (NCO:OH ratio 1.05:1), and mixing was continued for about 90 seconds, until the diol was visually mixed into the prepolymer. The reaction mixture was then poured into an open-faced mold and placed into an oven for post cure at 110° C. for 16 hours.

### Example 3

This example illustrates preparation of a diisocyanate-terminated polytrimethylene ether-urethane prepolymer for use in subsequent reaction with chain extender and chain terminator to prepare the compositions of the invention.

Polytrimethylene ether glycol (937.1 g) of molecular weight 2,000 was dried and then charged to a 2 liter four necked flask equipped with a mechanical stirrer, addition funnel, thermocouple, and a gas inlet adapter. Antioxidant (blend of IRGANOX 1076 and ETHANOX 300 (2.3 g)) was added to the polyol and allowed to mix completely. This mixture was then heated to 60° C. under an inert nitrogen atmosphere. Molten (50° C.) 4,4-diphenyl methane diisocyanate (541 g of ISONATE 125M) was added slowly to the mixture at a rate sufficient to maintain a reaction temperature of <70° C. The reactor was held at 70 to 80° C. until the NCO:OH reaction was complete. The prepolymer product was degassed and transferred hot to a clean dry plastic container and sealed under a nitrogen atmosphere for later use.

### Example 4

This example illustrates preparation of polyurethane of the invention by reaction of the prepolymer prepared in Example 3 with 1,4-butanediol diol chain extender, and n-butanol monofunctional chain terminator.

An aliquot (273 g) of diisocyanate-terminated polytrimethylene ether-urethane prepolymer from Example 3, having a % NCO content of 9.68%, was transferred to another reactor and kept at 60° C. A preheated mixture of 1,4-butanediol (27.5 g) and n-butanol (0.34 g) were added to the prepolymer. Mixing was continued for about 90 seconds, until the diol was visually mixed into the prepolymer. The reaction mixture was poured into an open-faced mold and placed into an oven for post-cure at 110° C. for 16 hours.

### Example 5

This example illustrates preparation of polyurethane of the invention by reaction of the prepolymer prepared in Example 3 with 1,4-butanediol diol chain extender, and n-butanol monofunctional chain terminator. In this example the level of chain terminator was higher than that in Example 4 to illustrate that the product compositions were extrudable at both chain terminator levels.

An aliquot (365 g) of diisocyanate-terminated polytrimethylene ether-urethane prepolymer prepared in Example 3 was transferred to another reactor and held at 60° C. A preheated mixture of 1,4-butanediol (36.6 g) and n-butanol (0.9 g) were added to the prepolymer. Mixing was continued for about 90 seconds, until the diol was visually mixed into the prepolymer. The reaction mixture was poured into an open-faced mold and placed into an oven for post-cure at 110° C. for 16 hours.

### Example 6

This example illustrates preparation of a polyurethane from polytrimethylene ether glycol, 4,4′-diphenyl methane diisocyanate, a mixture of 1,4-butanediol and of 1,3-propanediol chain extenders where 1,4-butanol was the primary chain extender, and n-butanol chain terminator.

Polytrimethylene ether glycol (2.1 kg) of molecular weight 2,420 was dried and then charged to a 5-L four-necked flask equipped with a mechanical stirrer, addition funnel, thermocouple, and a gas inlet adapter. An antioxidant blend of IRGANOX 1076 and ETHANOX 300 (4.8 g) was added to the polyol and allowed to mix completely. This mixture was then heated to 60° C. under an inert nitrogen atmosphere, and then 900 g of molten (50° C.) 4,4′-diphenyl methane diisocyanate was added slowly to the mixture at a rate sufficient to maintain a reaction temperature of <70° C. The reaction mixture was held at 70o to about 80° C. until the NCO:OH reaction was complete. The prepolymer product had a % NCO content of 7.60.

The entire amount of prepolymer was degassed in vacuum oven at 60° C. for two hours, and then a mixture of 235 g of 1,4-butanediol, 2.0 g of 1,3-propanediol and 2.94 g of n-butanol was added to the prepolymer in a round bottom flask at 60° C. The resulting reaction mixture was mixed thoroughly for about 90 seconds and then allowed to cure in the round bottom flask and then placed in an oven for post cure at 110° C. for 16 hours.

### Example 7

Polytrimethylene ether glycol (2.82 kg) having a number average molecular weight of 2,420 was dried and charged to a 5-L flask equipped with a mechanical stirrer, addition funnel, thermocouple, and gas inlet adapter. LOWINOX 1790 antioxidant (6.14 g) was added and allowed to mix completely. Then the mixture was heated to 60° C. under a nitrogen atmosphere. Methylene diphenyl diisocyanate (981 g) was added slowly to the reactor and allowed to mix for roughly two hours, at which time, a small sample was removed for analysis of NCO functionality present in the prepolymer. Percent NCO was 6.13%. The prepolymer was degassed under vacuum in the round bottom flask for 2 hours, and then a mixture of 242.5 g 1,4-butanediol, and 2.93 g n-butanol, preheated to 60 C, was added with stirring. Mixing was continued for 3.5 minutes, until the butanediol mixture was visually mixed into the prepolymer. The resulting mixture was allowed to cure in the flask, and then placed into an oven for post cure at 110° C. for 16 hours.

The properties of the polyurethane polymers prepared are listed in Table 1.

### Example 8

This example describes the results of melt spinning fibers from the melt polymerized polyurethane compositions described in Examples 4-7 and control Example 2. The fibers were spun from the compositions described in Examples 4 and 5 by the press spin unit procedure described above. Fibers were spun from the compositions described in Examples 6 and 7 by the semi-industrial spinning machine.

Attempts to melt spin fibers from the polyurethane prepared in control Example 2 using press spin unit, containing no monofunctional chain terminator, were not adequate due to filament breaks. This demonstrates that the comparative polytrimethylene ether urethanes, which do not contain monofunctional chain terminators, are not as well suited for melt-spinning and that this deficiency is overcome by the compositions of the invention.

Properties of monofilament fibers are presented in Table 2 and of multifilament fibers in Table 3.

TABLE 1
Properties of TPU

| | | | | Tg | Tm | Tc |
|---|---|---|---|---|---|---|
| Example | % HS | Mn | Mw | ° C. | ° C. | ° C. |
| 2 | 42 | 28650 | 57180 | −62 | 186; 209; 226 | 129 |
| 4 | 42 | 32990 | 59700 | −58 | 180 | 110 |
| 5 | 42 | 31040 | 54280 | −59 | 183; 208 | 113 |
| 6 | 35 | 33800 | 62740 | −63 | 177; 192; 211 | 113 |
| 7 | 30 | 41740 | 87590 | −62 | 173 | 98 |

Multiple hard segment melt transitions (Tm) over a broad temperature range were observed.

TABLE 2
Melt-spun Elastic Fiber (mono-filament) Properties

| | | Spin | | | | | | Stress | |
|---|---|---|---|---|---|---|---|---|---|
| | Draw | speed | | Tenacity | Elongation | | TM1 | Decay | Set |
| Exp. | Ratio | mpm | Den1 | (gpd) | (%) | Den 2 | (gpd) | (%) | (%) |
| 2 | Not melt spinnable | | | | | | | | |
| 4 | 1× | 210 | 31 | 1.19 | 400 | 27 | 0.13 | 27 | 57 |
| | 2× | 160 | 44 | 1.58 | 290 | 46 | 0.20 | 27 | 58 |
| | 4× | 300 | 31 | 2.46 | 190 | 34 | 0.49 | 24 | 67 |
| | 6× | 430 | 31 | 2.17 | 170 | 27 | 0.55 | 20 | 68 |
| 5 | 1× | 210 | 49 | 1.42 | 320 | 49 | 0.17 | 27 | 56 |
| | 2× | 160 | 35 | 2.14 | 200 | 36 | 0.44 | 24 | 66 |
| | 4× | 290 | 31 | 2.35 | 190 | 31 | 0.55 | 22 | 68 |
| | 5× | 360 | 16 | 2.21 | 170 | 14 | 0.66 | 23 | 69 |

Spin temperatures were in the range of 225-230° C. The TM1, stress decay and set measurements were made using zero-to-100% elongation cycles

TABLE 3
Melt-spun Elastic Fiber (multi-filament) Properties

| | | Spin | | | | | | Stress | |
|---|---|---|---|---|---|---|---|---|---|
| | Draw | speed | | Tenacity | Elongation | | TM1 | Decay | |
| Ex | Ratio | Mpm | Den1 | (g/d) | (%) | Den 2 | (g/d) | (%) | Set (%) |
| 6 | 5× | 1000 | 160 | 0.746 | 300 | 152 | 0.003 | 27 | 55 |
| | 5× | 750 | 232 | 0.713 | 290 | 252 | 0.0045 | 26 | 53 |
| 7 | 2.5× | 1125 | 82 | 0.477 | 313 | 83 | 0.0032 | 25 | 54 |
| | 2.5× | 1500 | 76 | 0.435 | 305 | 67 | 0.0029 | 25 | 57 |

Spin temperature was 230° C. for polymer in Example 6 and 210° C. for polymer in Example 7. A 13 hole 0.009 × 0.012 spinneret was used. The TM1, stress decay and set measurements were made using zero-to-300% elongation cycles.

The above examples demonstrate making melt spun fibers from the polyurethane compositions in an environmentally friendly process without use of solvent and use of bio-based polytrimethylene ether glycol ingredient. The data in Tables 2 and 3 indicate that the fibers, yarns and filaments of the present invention show a low stress decay or stress relaxation. This behavior is very similar to rubber, and superior to the dry-spun spandex elastomeric fibers. Further optimization of the process will achieve even better properties.

### Example 9

This example illustrates the preparation of polyurethane composition from polytrimethylene ether glycol for films.

934.3 g polytrimethylene ether glycol with a Mn of 1380 was added to a three neck round bottom flask under nitrogen purge. Vacuum was applied to the sample, and the temperature was raised to 105° C. for two hours. The temperature was reduced to 60° C., and 1.6931 g of LOWINOX 1790 antioxidant (Great Lakes Chemicals, West Lafayette, Ind.) was added to the polyol and allowed to fully mix in. 505.2 g of ISONATE 125M was added to the polyol and the reactor temperature raised to 80° C. The sample was reacted until the NCO content was measured at 7.85%. 117.5 g of 1,4-butanediol, mixed with 1.4677 g of n-butanol, was added to the prepolymer, and allowed to react until fully polymerized. The polymerized sample was placed into a 110° C. oven and heated for 16 hours.

### Comparative Example

This example illustrates the preparation of polyurethane composition from polytetramethylene ether glycol.

981.8 g TERATHANE 1000 (polytetramethylene ether glycol) was added to a three neck round bottom flask under nitrogen purge. Vacuum was applied to the sample, and temperature raised to 105° C. for two hours. The temperature was reduced to 60° C., and 1.8870 g of LOWINOX 1790 was added to the polyol and allowed to fully mix in. 574.6 g of ISONATE 125M was added to the polyol and the reactor temperature raised to 80° C. The sample was reacted until the NCO content was measured at 6.51%. 104.8 g of 1,4-butanediol, mixed with 1.2931 g of n-butanol, was added to the prepolymer, and allowed to react until fully polymerized. The polymerized sample was placed into a 110° C. oven and heated for 16 hours.

### Example 10

This example demonstrates preparation of polyurethane films.

The films were made using a 28 mm extruder (Werner & Pfliederer), equipped with Foremost #11 feeder, #3 casting drum, and #4 winder. The hopper and throat of the extruder had a nitrogen blanket.

Polyurethane crumb was fed through the hopper into the twin screw extruder. The sample was heated to melt and fed into a film die. The aperture of the die was set to roughly 5 mil thickness (1 mil= 1/1000 inches=25.4 microns) and the film was extruded continuously at the approximate rate of 3 feet per minute. The film was then cooled at 29° C. on a casting drum, which was equipped with a cooling water jacket. The cooled film was then wound onto a roll with a winder. The temperatures of the extruder zones and dye are listed in Table 4.

TABLE 4
Process conditions for film making

| | Zone Temperatures (° C.) | | | | | Die |
|---|---|---|---|---|---|---|
| EX | 1 | 2 | 3 | 4 | 5 | (° C.) |
| Comp Ex | 137 | 197 | 211 | 210 | 206 | 196 |
| Ex 9 | 136 | 199 | 209 | 210 | 210 | 209 |

TABLE 5
Properties of TPU films

| | | Comp | |
|---|---|---|---|
| Property | Test Method | Example | Example 9 |
| Film thickness, mils | | 5.0 | 5.5 |
| Water absorption (24 h), % | ASTM D570 | 1.7 | 3.2 |
| Water Vapor Transmission | ASTM F1249 | 397 | 875 |
| Rate, gm/(m²-day) | | | |
| Water Vapor Permeation | | 1983 | 4834 |
| Rate, mil-gm/(m²-day) | | | |
| Stress at break, ksi | ASTM D882-02 | 3.316 | 3.380 |
| Stress at 10% strain, ksi | | 0.268 | 0.263 |
| Strain at break, % | | 395 | 985 |

It is evident from Table 5 that the polytrimethylene ether glycol based polyurethane film of the invention has very good mechanical properties (such as tensile strength, and toughness), outstanding elastic (strain) properties and superior breathability over polytetramethylene glycol based urethanes. The combination of high water vapor permeability rate with excellent mechanical and elastic properties is very unique to polytrimethylene ether glycol based urethane films. Textile coatings and wound dressing films require a large water vapor permeation rate for optimum comfort during use.

The foregoing disclosure of embodiments of the invention has been presented for purposes of illustration and description. It is not intended to be exhaustive or to limit the invention to the precise forms disclosed. Many variations and modifications of the embodiments described herein will be obvious to one of ordinary skill in the art in light of the disclosure.

What is claimed is:

1. A thermoplastic polyurethane prepared from reactants comprising:
(a) polytrimethylene ether glycol;
(b) diisocyanate;
(c) diol chain extender; and
(d) monofunctional alcohol chain terminator or monofunctional amine chain terminator.

2. The thermoplastic polyurethane of claim 1 wherein the monofunctional alcohol or amine chain terminator is a monofunctional alcohol selected from the group consisting of n-butanol, n-hexanol, n-octanol, n-decanol, n-dodecanol and mixtures thereof.

3. The thermoplastic polyurethane-urea of claim 1 wherein the monofunctional alcohol or amine chain terminator is a monofunctional amine selected from the group consisting of ethyl amine, propylamine, butyl amine, octyl amine, stearyl amine and mixtures thereof.

4. The thermoplastic polyurethane of claim 1 wherein the monofunctional alcohol selected from the group consisting of n-butanol, n-hexanol, n-octanol, n-decanol, n-dodecanol and mixtures thereof; the monofunctional amine selected from the group consisting of ethyl amine, propylamine, butyl amine, octyl amine, stearyl amine and mixtures thereof; the diol chain extender is selected from the group consisting of ethylene glycol, 1,2-propylene glycol, 1,3-propanediol, 1,4-butanediol, 1,6-hexanediol, diethylene glycol, 2-methyl-1,3-propanediol, 3-methyl-1,5-pentanediol, 2,2-dimethyl-1,3-propanediol, 2,2,4-trimethyl-1,5-pentanediol, 2-methyl-2-ethyl-1,3-propanediol, 1,4-bis(hydroxyethoxy)benzene, bis(hydroxyethylene)terephthalate, hydroquinone bis(2-hydroxyethyl) ether, and mixtures thereof; and the diisocyanate is selected from the group consisting of 2,4-toluene diisocyanate, 2,6-toluene diisocyanate, 4,4′-diphenylmethane diisocyanate, 4,4′-dicyclohexylmethane diisocyanate, 3,3′-dimethyl-4,4′-biphenyl diisocyanate, 1,4-benzene diisocyanate, cyclohexane-1,4-diisocyanate, 1,5-naphthalene diisocyanate, 1,6-hexamethylene diisocyanate, 4,6-xylyene diisocyanate, isophorone diisocyanate, and mixtures thereof.

5. The thermoplastic polyurethane of claim 1 wherein the ratio of total hydroxyl and amine groups contained in the polytrimethylene ether glycol, diol chain extenders and monofunctional alcohol or amine chain terminators to isocyanate groups in the diisocyanate is about 1:0.95 to about 1:1.1.

6. The thermoplastic polyurethane of claim 1 wherein the ratio of total hydroxyl and amine groups contained in the polytrimethylene ether glycol, diol chain extenders and monofunctional alcohol or amine chain terminators to isocyanate groups in the diisocyanate is from about 1:0.98 to about 1:1.05.

7. The thermoplastic polyurethane of claim 1 wherein the polytrimethylene ether glycol is blended with up to about 50 wt. % of other polymeric glycols selected from the group consisting of hydroxyl terminated polyether glycols, polyester glycols, polycarbonate glycols and silicone glycols.

8. The thermoplastic polyurethane of claim 1 wherein the polytrimethylene ether glycol is blended with up to about 25 weight % of other polymeric glycols selected from the group consisting of hydroxyl terminated polyether glycols, polyester glycols, polycarbonate glycols and silicone glycols.

9. The thermoplastic polyurethane of claim 1 wherein the polytrimethylene ether glycol is not blended with other polymeric glycols.

10. The thermoplastic polyurethane of claim 4 wherein the ratio of total hydroxyl and amine groups contained in the polytrimethylene ether glycol, diol chain extenders and monofunctional alcohol or amine chain terminators to isocyanate groups in the diisocyanate is about 1:0.95 to about 1:1.1, and wherein the polytrimethylene ether glycol is blended with 0 to about 25 weight % of other polymeric glycols.

11. The thermoplastic polyurethane of claim 10, wherein the other polymeric glycols are polyether glycols selected from the group consisting of homo or copolyethers of polyethylene glycol, poly(1,2-propylene glycol), polytetramethylene ether glycol and mixtures thereof.

12. The thermoplastic polyurethane of claim 1 wherein about 75 to 100 mole percent of the repeat units of the polytrimethylene ether glycol are trimethylene ether units.

13. The thermoplastic polyurethane of claim 10 wherein about 90 to 100 mole percent of the repeat units of the polytrimethylene ether glycol are trimethylene ether units.

14. A thermoplastic polyurethane comprising:
(a) 80 to 20 weight %, by weight of the thermoplastic polyurethane, soft segment containing repeat units from polytrimethylene ether glycol;
(b) 20 to 80 weight %, by weight of the thermoplastic polyurethane, hard segment comprising repeating units from diisocyanate and from diol chain extender; and
(c) chain termination units from monofunctional alcohol chain terminator or monofunctional amine chain terminator;
wherein the ratio of total hydroxyl and amine groups contained in the polytrimethylene ether glycol, diol chain extenders and monofunctional alcohol or amine chain terminators to isocyanate groups in the diisocyanate is from about 1:0.95 to about 1:1.1.

15. A shaped article comprising the thermoplastic polyurethane of claim 1.

16. The shaped article of claim 15 selected from the group consisting of fibers, films, sheets, hoses, tubing, wire and cable jackets, shoe soles, air bag bladders and medical devices.

17. A melt spun fiber comprising the thermoplastic polyurethane of claim 1.

18. The melt spun fiber of claim 17 wherein the fiber is a monofilament or multifilament fiber.

19. A woven or knit fabric comprising the fiber of claim 18.

20. A film comprising the thermoplastic polyurethane of claim 1.

21. A film as claimed in claim 20 wherein the thickness of the film is from about 5 μm to 500 μm.

22. A water vapor permeable membrane comprising the films of claim 20.

23. The water vapor permeable membrane according to claim 22 wherein said polyurethane film has a water vapor permeability rate of at least about 2500 mil-gm/m²/day

24. A water impermeable, water vapor permeable fabric comprising a substrate and a polyurethane film according to claim 22.

25. A process of producing thermoplastic polyurethane comprising:
(a) reacting diisocyanate and polytrimethylene ether glycol to form diisocyanate-terminated polytrimethylene ether-urethane prepolymer; and
(b) reacting the diisocyanate-terminated polytrimethylene ether-urethane prepolymer with diol chain extender and monofunctional alcohol or amine chain terminator.

26. The process of claim 25 wherein the reacting the diisocyanate and polytrimethylene ether glycol is carried out while maintaining an NCO:OH equivalent ratio of about 1.1:1 to about 10:1, and wherein the ratio of total hydroxyl and amine groups contained in the polytrimethylene ether glycol, diol chain extenders and monofunctional alcohol or amine chain terminators to isocyanate groups in the diisocyanate is about 1:0.95 to about 1:1.1.

27. The process of claim 26 that is performed in an extruder at a temperature of from about 100° C. to about 220° C.

28. A process of producing thermoplastic polyurethane comprising:
(a) providing (i) diisocyanate, (ii) polytrimethylene ether glycol, (iii) diol chain extender; and (iv) monofunctional alcohol or amine chain terminator; and
(b) reacting the diisocyanate, the polytrimethylene ether glycol, the diol chain extender and the monofunctional alcohol or amine chain terminator.

29. The process of claim 29 wherein the ratio of total hydroxyl and amine groups contained in the polytrimethylene ether glycol, diol chain extenders and monofunctional alcohol or amine chain terminators to isocyanate groups in the diisocyanate is about 1:0.95 to about 1:1.1.

30. A process of forming a shaped article comprising providing the thermoplastic polyurethane of claim 1 and melt processing the thermoplastic polyurethane to form a shaped article.

31. A process of forming a fiber comprising providing the thermoplastic polyurethane of claim 1 and melt spinning the thermoplastic polyurethane into a fiber.
